(19) United States
(12) Patent Application Publication
(10) Pub. No.: US 2009/0279658 A1
(43) Pub. Date: Nov. 12, 2009

(54) MOLTEN SALT NUCLEAR REACTOR

(75) Inventor: David Leblanc, Ottawa (CA)

Correspondence Address: BORDEN LADNER GERVAIS LLP;Anne Kinsman, WORLD EXCHANGE PLAZA, 100 QUEEN STREET SUITE 1100, OTTAWA, ON, K1P 1J9, CA

(73) Assignee: OTTAWA VALLEY RESEARCH ASSOCIATES LTD., Ottawa (CA)

(21) Appl. No.: 12/118,118

(22) Filed: May 9, 2008

(51) Int. Cl. G21C 1/22

(52) U.S. Cl. 376/360

(57) ABSTRACT

A molten salt breeder reactor that has fuel conduit surrounded by a fertile blanket. The fuel salt conduit has an elongated core section that allows for the generation of electrical power on a scale comparable to commercially available nuclear reactors. The geometry of the fuel conduit is such that sub-critical conditions exist near the input and output of the fuel salt conduit and the fertile blanket surrounds the input and output of the fuel salt conduit, thereby minimizing neutron losses.

### FIELD OF THE INVENTION

The present invention relates generally to nuclear reactors. More particularly, the present invention relates to molten salt nuclear reactors.

### BACKGROUND OF THE INVENTION

The following is a list of definitions of terms used herein:

Carrier Salt: a salt added to fissile and/or fertile salts. The purpose of the carrier salt is primarily to form a low melting point eutectic with good thermodynamic and neutronic properties. An example of a well-known carrier salt is 2⁷LiF—BeF₂

Fuel Salt: a molten salt containing fissile material such as, for example, ²³³UF₄, ²³⁵UF₄, and PuF₃. It can also contain fertile material such as, for example, ThF₄ or ²³⁸UF₄.

Blanket Salt: a molten salt containing fertile material such as, for example, ThF₄.

Moderator: materials within the reactor that slow down fission produced neutrons. An example of a moderator material is graphite but other materials can be considered. Carrier salts themselves can be moderator materials.

Thermal Spectrum: refers to a moderated neutron energy spectrum with a significant fraction of neutrons near thermal energy.

Fast Spectrum: a neutron energy spectrum in which there is very little slowing down of the neutrons, i.e., where the neutrons have a high average energy.

Epithermal Spectrum: an intermediate neutron energy spectrum that can range from a softer more thermal spectrum to a harder or faster spectrum.

Temperature and Void Coefficients: these are values that indicate how a reactor reacts to changes in temperature of fuel, moderator materials or to voids developing in the fuel salt and/or the blanket salt. Negative coefficients are always desired in order that any over power or loss of cooling will result in an automatic decrease in reactor power output.

Core Region: a region of the core of a reactor, typically an inner region, which is a net producer of neutrons.

Blanket Region: a region of the core of the reactor, typically an outer region, which is a net absorber of neutrons due to the presence of significant amounts of fertile material. It is a net producer of fissile elements.

Breeder Reactor: a reactor that produces more fissile material than it consumes. This results from the use of fertile material such as thorium or depleted uranium and a good neutron economy. A Breeding Ratio above 1.0 characterizes it.

Break Even Reactor: a reactor that produces just enough fissile material to cover consumption. It has a breeding ratio of 1.0. For such reactors, only fertile material needs to be brought to the nuclear plant after startup of the reactor and no fissile material need leave the plant.

Doubling Time: refers to the number of years in which a breeder reactor must run and produce excess fissile material to cover the starting load of a new similar breeder reactor. The doubling time is a function of both the breeding ratio and the starting fissile load needed (specific inventory).

Single Fluid Reactor: a molten salt reactor in which the fissile and fertile materials are both contained in a single fluid. For example, the single fuel can include ²³³U as fissile and Thorium as fertile.

Two Fluid Reactor: a nuclear reactor in which there are separate fluids for the fissile (fuel salt) and fertile (blanket salt) elements. In reactors where the fuel salt also contains some quantity of fertile thorium, these have been referred to as a One and a Half Fluid Reactors.

Fluoride Volatility: refers to a method for the extraction of elements that can form volatile fluorides. By this method, the uranium content of a salt can be removed by bubbling of HF followed by bubbling of F₂ gas through the salt which converts UF₄ to volatile UF₆. This UF₆ can later be converted back to UF₄.

Vacuum Distillation: a fission product removal technique in which low-pressure distillation boils off carrier salts leaving behind fission products. The carrier salts can then be condensed and reused. If any thorium is present, as would be for a Single Fluid Reactor, the thorium would be left behind with the fission products.

Protactinium: the 27-day half-life intermediate between thorium and fissile ²³³U. Removing it from the salt for external storage before decay is thought necessary in some designs depending on the average neutron fluence it would experience in the core.

Liquid Bismuth Extraction: an often expensive and complex technique of contacting the fuel salt with liquid bismuth to remove fission products, protactinium and/or transuranics. The advantage being it can operate in the presence of thorium.

Salt Replacement: the simplest form of fission product processing is where the uranium content is first removed by fluoride volatility and this uranium is combined with new clean salt to be sent back to the core. This occurs, typically after a few month waiting period to allow protactinium to convert to ²³³U. The used salt, containing fission products and perhaps transuranics and thorium, can go to long-term storage or further processing to recycle the transuranic or thorium content.

Denatured Uranium: the term used for uranium containing less than 20% ²³⁵U or 12% ²³³U (or a weighted combination). Denatured uranium is not classified as bomb grade material by the IAEA (International Atomic Energy Agency).

Hastelloy™ N: a nickel based alloy commonly used in molten fluoride salt systems due to low corrosion rates up to approximately 750° C.

Molten salt nuclear reactors (MSNRs) have been known since the 1940s. Such reactors operate on fluid fuels that contain fissile, and sometimes fertile, elements mixed in with carrier salts to produce a low melting point eutectic mixture. During operation of the nuclear reactor, the fluid fuel passes through a nuclear core region where criticality is reached causing the temperature of the fluid fuel to increase. The heated fluid fuel then propagates to a heat exchanger system where the heat energy is harvested and transformed into electricity.

Different designs of MSNRs used to produce electrical power and to breed fissile fuel are known and usually referred to as breeder reactors. These include Two-Fluid, Single-Fluid and one-and-a-half fluid reactors. Known Two-Fluid reactors have either a spherically-shaped inner fissile fuel enclosure adjacent a separate fertile blanket that surrounds the fissile fuel enclosure or, a series of spaced-apart graphite tubes carrying a fissile fuel, with the series of tubes submerged in a fertile fuel. These MSNRs are such that criticality conditions are reached and maintained in their core in order to generate heat and produce neutrons, some neutrons being captured by the fertile elements of the fertile blanket to produce additional fissile elements. Prior art Single-Fluid reactors have a fissile fuel conduit that contains both fissile and fertile elements, the fissile fuel conduit being surrounded by graphite. As for prior art one-and-a-half fluid reactors, one of them has the same geometry as that of the Two-Fluid reactor described above but with the spherically-shaped inner fissile fuel enclosure containing both fissile and fertile elements and being surrounded by a separate fertile fuel blanket.

Much work was carried out at the Oak Ridge National Laboratories (ORNL) from the mid 1950s to the mid 1970s to develop molten salt breeder reactors that would allow the rapid generation of sufficient fissile elements to start-up similar reactors. These reactors were said to have short fissile material doubling times. Initial work produced the simple Two-Zone reactor shown at FIG. 1, which shows the layout of the inner spherical core through which can flow a fissile fuel salt or a mixture of fissile and fertile salts to function as Two-Fluid and one-and-a-half-fluid reactors respectively, the inner spherical core being surrounded by a blanket enclosure through which flows the fertile salt. For the reactor of FIG. 1 operating on a fuel salt containing fissile uranium and a blanket salt containing fertile thorium, i.e., operating as a Two-Fluid reactor, it can be shown that in order to avoid having the reactor becoming super-critical, the inner diameter of the spherical fissile fuel enclosure must be of the order of 1 meter or, the concentration of fissile elements in the fissile fuel must be very low. Neither option is conducive to both a practical power output and a breeding ratio of 1.0 or above. In an attempt to improve on these, ORNL added a fertile thorium salt to the fuel salt to operate the reactor as a one-and-a-half-fluid reactor. However, it was recognized that the presence of thorium in the fuel salt would make processing for fission products problematic as thorium behaves chemically much like the important rare earth fission products, which makes it very difficult to remove fission products without also removing the thorium. The nuclear reactor shown at FIG. 1 has a fuel salt 1000, a barrier 1002, a blanket salt 1004, an outer vessel wall 1006, a blanket salt input 1008, a fuel salt input 1010, a fuel salt output 1012, a fuel salt pump 1014 and a blanket salt pump 1016.

Starting around 1959 it was decided at ORNL to focus on reactor designs in which graphite is used as a neutron moderator. These were believed to offer improved breeding ratios and lowered specific inventory, which offered the possibility to better compete with sodium cooled fast breeders reactors. As early as 1960 it was established that a true Two-Fluid reactor that kept fissile ²³³U and fertile thorium in completely separate salt streams was important for ease of fission product processing. As well, Two-Fluid reactors offered the ability to lower neutron losses due to Protactinium 233 (²³³Pa), which is the 27-day half-life intermediate element between fertile thorium and fissile uranium. This result was achieved by increasing the volume of blanket salt such that the average neutron flux seen by the produced ²³³Pa was lowered. Nevertheless, due to the absence of thorium in the core region, there was still the problem of the upper limit of power density within the core region due to the neutron induced swelling of the graphite. That is, the volume of the core would have had a maximum value beyond which the reactor was super-critical, but this maximum volume was still too small to provide a useful output power. Specifically, for a reactor of this type, the diameter of the spherical core would have been on the order of 3 m for a typical power plant. This meant that the critical concentration needed for ²³³UF₄ would be so low that parasitic neutron absorption in the carrier salt and graphite would have dominated and rendered breeding virtually impossible.

The solution proposed at that time involved an elaborate plumbing system that allowed a fertile thorium blanket salt to flow within the core region but at the same time kept it separate from the fuel salt. This effectively allowed larger core diameters and sufficient power producing volume. As adding any metal would be detrimental to breeding ratios because of neutron absorption, the use of graphite itself as the plumbing material became the focus of such breeder reactors. The basic concept is shown at FIG. 2, which is based on an ORNL depiction. In the reactor of FIG. 2, fuel salt flows up and back down graphite fuel salt tubes and a fertile thorium blanket salt flows between these tubes. In this reactor, the core is defined by the volume of blanket salt present between the graphite tubes and by the volume occupied by the graphite tubes themselves. The dimensions of each individual tube and the concentration of fissile elements in the fissile fuel flowing in each graphite tube were such that each graphite tube by itself was sub-critical. A self-sustaining nuclear reaction (criticality) was only possible with such graphite tubes being disposed proximate each other. For simplicity, only four of several hundred graphite tubes are depicted at FIG. 2. However, the behavior of graphite under radiation (shrinking and then swelling) proved to be a major hurdle since a changing tube diameter would mean a changing volume of blanket salt between tubes, which adversely affects reactivity. Another issue with this Two-Fluid design is that the blanket salt would have positive temperature or void reactivity coefficients, which runs counter to standard design practice. This Two-Fluid reactor design was eventually dismissed after many years effort. The nuclear reactor of FIG. 2 is shown with a fertile salt input 2000, a fertile salt output 2002, an outer vessel 2004, a fertile blanket salt 2006, graphite fuel salt tubes 2008, a fertile salt input 2010, a fertile salt output 2012, a plenum 2014 and a control rod 2016.

The plumbing problems of the Two-Fluid reactor of FIG. 2 combined with the development of a liquid bismuth extraction method as a way to process fission products and/or protactinium, even with thorium present in the fuel salt, allowed for the processing of fuel in Single-Fluid reactors. A change in focus at ORNL towards a graphite moderated Single-Fluid design took place in and around 1968.

FIG. 3 shows a basic layout of a graphite moderated Single-Fluid reactor. The core of this reactor consists of graphite moderator blocks defining fuel channels through which flows a molten salt containing both fertile thorium and fissile uranium. In FIG. 3 the central fuel channels were dimensioned to obtain the optimum volumetric ratio of salt to graphite is about 13% in order to obtain the best breeding ratio. In the outer radial annulus region however, the channels were made larger such that the salt occupies about 37% of the volume. This arrangement results in under moderation and leads to the outer annulus being a net absorber of neutrons, which acts to lower the percentage of neutrons lost by leakage; however, the neutron loss is still an order of magnitude larger than for the previous Two-Fluid reactors. The nuclear reactor 3000 of FIG. 3 has fuel channels 3002, a graphite moderator 3004, a primary salt pump 3006, a heat exchanger 3008, a coolant salt input 3010, a coolant salt output 3012, a conduit 3014 that guides the fuel salt from the heat exchanger to the reactor, a freeze plug 3016 and dump tanks 3018.

While the advent of the Liquid Bismuth Extraction technique allowed a new method of fission product processing, it was by no means a simple process. It involved removing all Protactinium produced on a 3 to 10 day cycle and allowing it decay to ²³³U in storage tanks. The removal of fission products with thorium present is possible but it does make the process much more complex as thorium behaves chemically much like the important rare earth fission products. Thus the overall process of fissile material extraction required many elaborate steps to remove several families of fission products separately without taking the thorium at the same time. A 20-day processing time was typically quoted but this was a combination of some fission products being removed faster and some slower, depending on the extraction efficiency. The net result was a Single-Fluid reactor with a specific inventory of 1500 kg, a breeding ratio of 1.06, a doubling time of about 20 years and a graphite lifetime of 4 years.

Another issue with prior art molten salt reactor relates to their limited ability to burn transuranic (TRU) waste produced by, for example, light water reactors (LWRs). Molten salt reactors in general have long been recognized as providing a good method for the destruction of these materials, for among other reasons, the lack of need to fabricate solid fuel elements. In several studies however, the limited solubility of PuF₃ and the other tri-fluoride TRUs has lead to difficulties. Alternative carrier salts such as NaF—ZrF₄ have been proposed that have higher solubility than 2LiF—BeF₂ and also do not lead to tritium production as lithium and beryllium do. However these studies with NaF—ZrF₄ have concluded that the concentration of TRUs in the fuel salt cannot be maintained high enough to keep those prior art molten salt reactors critical, even with rapid fission product removal. Proposals using a NaF—LiF—BeF₂ carrier salt have shown promise but this salt brings back increased tritium production. As well, in these proposals, the destruction of TRUs is never really complete due to the fact that at the end of the reactors lifetime, there still exists up to several tonnes of TRUs in the salt. This limited reactivity problem only occurs after several months of operation, which is due to the fact that the initial fissile to fertile ratio in LWR wastes is quite high, but drops significantly as it is fissioned in a TRU burner reactor.

The issue of using low enriched uranium (LEU) as a startup fuel in prior art molten salt reactors was seen as attractive because of the lowered proliferation risk it offered. However, it has generally been ruled out. The reason for this is that the presence of ²³³U in the fuel salt means that plutonium will be produced in much larger quantities than in a pure Th—²³³U cycle (Th—²³³U cycle: thorium in a blanket that surrounds a fuel salt and produces ²³³U, which is subsequently extracted and transferred to the fuel salt). Processing of the fuel salt is thus complicated by the presence of Pu and the other trans-plutonium elements. As well, even though LEU is probably only needed for the initial specific inventory, it would take years, if not decades to burn off the ²³³U and the transuranics it produces.

The issue of operating prior art MSNRs on denatured uranium for the lifetime of the reactor was either never seriously considered or, in the case of Single-Fluid graphite moderated reactors, deemed to be barely able to attain a break even breeding ratio.

Therefore, it is desirable to provide a molten salt nuclear reactor that has a geometric arrangement that can produce electrical power in practical quantities and have a breeding ratio of at least 1.0. Further, it is desirable to provide a molten salt nuclear reactor that has a simple physical layout and that is made of materials that are easy to maintain. Further yet, it is desirable to provide a molten salt nuclear reactor that requires only relatively simple salt processing steps. Additionally, it is desirable to provide a molten salt nuclear reactor that can efficiently burn transuranic elements, can startup on transuranic elements and can startup on low enriched uranium. Furthermore, it is desirable to provide a molten salt nuclear reactor that has negative temperature and void coefficients for both the fuel salt and the blanket salt. It is also desirable to develop a method that enables operation while maintaining all uranium in a denatured state.

### SUMMARY OF THE INVENTION

It is an object of the present invention to obviate or mitigate at least one disadvantage of previous molten salt nuclear reactors.

In a first aspect, the present invention provides a molten salt nuclear reactor that comprises a fuel salt conduit having an input end section, an output end section and an elongated nuclear core section formed between the input end section and the output end section, the fuel salt conduit to guide a molten fuel salt between the input end section and the output end section. The molten fuel salt has a pre-determined concentration of fissile material, the elongated nuclear core section has a length and a cross-section dimensioned in accordance with the pre-determined concentration of fissile materials to obtain criticality within the elongated core section.

In an embodiment of the present invention, the reactor comprises a breeding section formed adjacent the fuel salt conduit, the breeding section to contain fertile nuclear elements and to receive neutrons generated in the elongated nuclear core section to produce fissile elements from the fertile nuclear elements.

In a further embodiment, the breeding section reflects a portion of the neutrons received from the elongated nuclear core section back towards the elongated nuclear core section, and the length and the cross-section of the elongated nuclear core section are dimensioned in further accordance with the portion of neutrons reflected.

In a further embodiment, the breeding section surrounds the fuel salt conduit to maximize the probability of capture by the fertile elements of the breeding section of the neutrons generated in the elongated nuclear core section.

In a further embodiment, at least one of the input end section and the output end section has a girth that diminishes as the at least one of the input end section and the output end section extends away from the elongated nuclear core section.

In a further embodiment, the breeding section can be a fertile salt conduit that propagates a molten breeder salt that includes the fertile nuclear elements.

In a further embodiment, the fuel salt conduit can be located inside the fertile salt conduit; and the molten breeder salt can surround the fertile salt conduit.

In a further embodiment, the elongated core section can be a cylinder.

In a further embodiment, the reactor can comprise a fuel salt heat exchanger system connected to the fuel salt conduit.

In a further embodiment, the reactor can comprise a breeder salt heat exchanger system connected to the fertile salt conduit.

In a further embodiment, the reactor can comprise a neutron moderator material formed inside the elongated nuclear core section.

In a further embodiment, the neutron moderator material can be graphite.

In a further embodiment, the breeding section can be a solid structure.

In a further embodiment, the solid structure can be graphite matrix containing at least one of thorium metal, thorium carbide, thorium fluoride and thorium dioxide.

In a further embodiment, the reactor can comprise a vessel that houses the fuel salt conduit and the breeding section.

In a further embodiment, the vessel can be made of a corrosion resistant metal alloy.

In a further embodiment, the elongated nuclear core section can gradually increases in width between the input end section and the output end section.

In a further embodiment, the fuel salt conduit can be made of at least one of a corrosion resistant alloy, graphite, carbon composite, molybdenum and stainless steel.

In a further embodiment, the neutron moderator material can be in the form of at least one graphite tube through which the molten fuel salt flows.

In a further embodiment, the neutron moderator material can be in the form of a plurality of graphite tubes through which the molten fuel salt flows.

In a further embodiment, the graphite tubes can be stacked up on each other. In a further embodiment, a portion of the at least one graphite tube can have an exterior hexagonal cross-section.

In a further embodiment, the neutron moderator material can be in the form of a plurality of graphite pebbles.

In a further embodiment, a portion of the graphite pebbles can be shaped as spheres.

In a further embodiment, the elongated reactor core can be made of graphite.

In a further embodiment, the elongated core region can include a beryllium compound.

In a further embodiment, the reactor can comprise of an enclosed volume of heavy water.

In a further embodiment, the reactor can comprise a neutron moderator material located substantially at the center of the elongated core.

In another aspect of the present invention there is provided a molten salt nuclear reactor. The reactor comprises a fuel salt conduit has an input end section, an output end section and an elongated nuclear core section formed between the input end section and the output end section, the fuel salt conduit to guide a molten fuel salt between the input end section and the output end section through the nuclear core section, the molten fuel salt has a pre-determined concentration of fissile materials, the elongated nuclear core section has a length and a cross-section dimensioned in accordance with the pre-determined concentration of fissile materials to obtain criticality within the elongated core section, the fuel salt conduit contains at least one of thorium metal, thorium carbide, thorium fluoride and thorium dioxide.

In an embodiment of the present invention, the fuel salt conduit includes a graphite matrix in which are contained at least one of thorium metal, thorium carbide, thorium fluoride and thorium dioxide.

In another aspect of the invention, there is provided a method of operating a molten salt nuclear reactor (MSNR). The method comprises a step of producing a self-sustaining nuclear reaction by providing a first denatured uranium salt to a fuel salt conduit of the MSNR, the fuel salt conduit having an elongated core section, the first denatured uranium salt having a concentration of fissile uranium such that criticality is achieved in the elongated core section, the self-sustaining nuclear reaction producing neutrons. The method comprises a further step of producing an augmented concentration denatured uranium salt by providing a fertile salt adjacent the fuel salt conduit, the fertile salt containing a thorium salt and a second denatured uranium salt, a portion of thorium atoms of thorium compounds of the thorium salt capturing neutrons produced in the elongated core section to transmute into ²³³U atoms to produce ²³³U compounds, the ²³³U compounds increasing an initial concentration of fissile uranium in the second denatured uranium salt to produce the augmented concentration denatured uranium salt. The method comprises a further step of removing the augmented concentration denatured uranium salt from the fertile fuel salt. The method comprises a further step of replacing the augmented concentration denatured uranium salt with a replacement denatured uranium salt having a concentration of fissile uranium lower than that of the augmented concentration denatured uranium salt. The method comprises a further step of adding thorium salt to the fertile salt to replace thorium atoms that have transmuted into ²³³U. Additionally, the method comprises a step of adding a portion of the augmented concentration denatured uranium salt to the fuel salt to maintain criticality in the elongated core section.

In a further aspect, there is provided a method of operating a molten salt nuclear reactor (MSNR). The method comprises a step of producing a self-sustaining nuclear reaction by providing a fuel salt containing transuranic fissile elements to a fuel salt conduit of the MSNR, the fuel salt conduit having an elongated core section, the fuel salt having a concentration fissile elements such that criticality is achieved in the elongated core section, the self-sustaining nuclear reaction producing neutrons. The method comprises a further step of producing ²³³U compounds by providing a fertile salt adjacent the fuel salt conduit, the fertile salt containing a thorium salt, a portion of thorium atoms of thorium compounds of the thorium salt capturing neutrons produced in the elongated core section to transmute into ²³³U atoms to produce the ²³³U compounds. The method further comprises steps of: extracting the ²³³U compounds from the fertile fuel salt; and adding a portion of the extracted ²³³U compounds to the fuel salt to maintain criticality in the elongated core section.

In a further aspect, there is provided method of producing ²³³U in a molten salt nuclear reactor. The method comprises a step of producing a self-sustaining nuclear reaction by providing a fuel salt containing transuranic fissile elements to a fuel salt conduit of the MSNR, the fuel salt conduit having an elongated core section, the fuel salt having a concentration of transuranic fissile elements such that criticality is achieved in the elongated core section, the self-sustaining nuclear reaction producing neutrons. The method comprises a further step of producing ²³³U compounds by providing a fertile salt adjacent the fuel salt conduit, the fertile salt containing a thorium salt, a portion of thorium atoms of thorium compounds of the thorium salt capturing neutrons produced in the elongated core section to transmute into ²³³U atoms to produce the ²³³U compounds. Additionally, the method comprises a step of extracting the ²³³U compounds from the fertile fuel salt.

In another embodiment, the method can include a step of replacing the fuel salt containing the transuranic fissile elements with a fuel salt containing the extracted ²³³U compounds.

In a further aspect, there is provided a method of running a molten salt nuclear reactor on a Th—²³³U cycle. The method comprises a step of producing a self-sustaining nuclear reaction by providing a low enriched uranium (LEU) fuel salt to a fuel salt conduit of the MSNR, the fuel salt conduit having an elongated core section, the LEU fuel salt having a concentration of fissile uranium such that criticality is achieved in the elongated core section, the self-sustaining nuclear reaction producing neutrons. The method comprises a further step of producing ²³³U compounds by providing a fertile salt adjacent the fuel salt conduit, the fertile salt containing a thorium salt, a portion of thorium atoms of thorium compounds of the thorium salt capturing neutrons produced in the elongated core section to transmute into ²³³U atoms to produce the ²³³U compounds until a pre-determined start-up quantity of ²³³U compounds is reached. Additionally, the method comprises a step of replacing the LEU fuel salt with a fuel salt comprising the pre-determined start-up quantity of ²³³U compounds.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

Embodiments of the present invention will now be described, by way of example only, with reference to the attached Figures, wherein:

FIG. 1 shows a prior art molten salt reactor;

FIG. 2 shows another prior art Two-Fluid molten salt reactor with graphite fuel salt conduits;

FIG. 3 shows a prior art Single-Fluid molten salt reactor;

FIG. 4 shows an embodiment of a molten salt reactor core assembly of the present invention;

FIG. 5 shows a cross-sectional view of the of FIG. 4;

FIG. 6 shows a plot of diameter as a function of cylinder length for a cylindrical nuclear reactor core;

FIG. 7 shows an exemplary nuclear plant having two molten salt core assemblies of FIG. 4;

FIG. 8 shows another embodiment of a molten salt reactor core assembly of the present invention;

FIG. 9 shows a cross-sectional view of another embodiment of a molten salt reactor core assembly of the present invention;

FIG. 10 shows a cut-out perspective view of the embodiment of FIG. 9;

FIG. 11 shows another embodiment of a molten salt reactor core assembly of the present invention;

FIG. 12 shows another embodiment of a molten salt reactor core assembly of the present invention;

FIG. 13 shows a cross-sectional view of another embodiment of a molten salt reactor core assembly of the present invention; and

FIG. 14 shows an embodiment of a nuclear plant using a single molten salt core assembly of the present invention.

### DETAILED DESCRIPTION

Generally, the present invention provides a molten salt nuclear reactor having an elongated core section in which criticality is achieved. The power producing volume of the elongated core section is such that considerably more power can be extracted in comparison with prior art molten salt nuclear reactors.

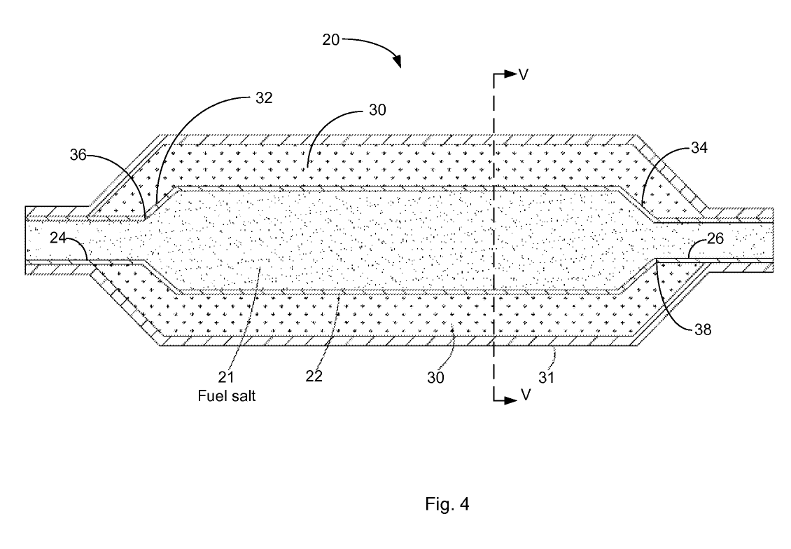

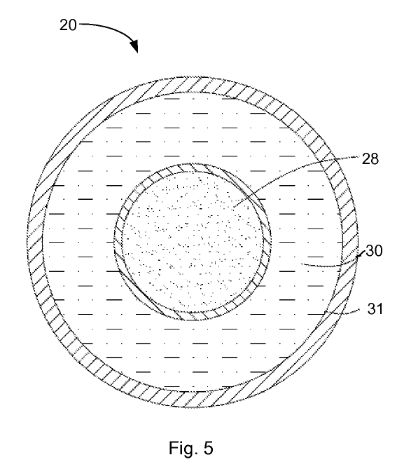

FIGS. 4 and 5 show an exemplary embodiment of a reactor core assembly 20 of the present invention. The reactor core assembly 20 has a fuel salt conduit 22 that has an input end section 24, an output end section 26 and an elongated core section 28, which is for guiding a molten fuel salt between the input end section 24 and the output end section 26. The dimensions of the elongated core section are chosen such that for a molten fuel salt having a pre-determined concentration of fissile elements, criticality is reached within the elongated core section. That is, the area of the cross-section (FIG. 5) of the elongated core section 28 and the length of the elongated core section 28 are such that a self-sustaining nuclear reaction takes place inside the elongated cores section 28 for a pre-determined concentration of fissile elements present in the molten fuel salt. The fuel salt conduit can be made of any suitable material such as, for example, a corrosion resistant alloy (e.g., Hastelloy™ N), graphite, carbon composites, stainless steel and molybdenum.

In the example of FIG. 5, the blanket 30 is defined by a vessel wall 31 and by the perimeter of the fuel salt conduit 22. The blanket 30 can contain any suitable type of fertile material such as, for example, thorium in the form of 27% ThF₄-73%⁷LiF. Neutrons generated within the elongated core section 28 transmit through the fuel salt conduit 22 and into the blanket 30. These neutrons can then interact with the fertile elements of the fertile salt to produce fissile elements. Typically, thorium will be the fertile element and will transmute to ²³³U upon neutron capture. Therefore, the reactor core assembly 20 is a breeder reactor core assembly. Any suitable method, such as, for example, the fluoride volatility process, can be used for extracting the fissile materials produced in the fertile fuel salt contained in the blanket 30.

Exemplary approximate dimensions of the elongated core section 28 can be obtained, by various reactor physics techniques once a carrier salt plus fissile and/or fertile concentration is chosen along with the makeup of the fuel salt conduit and the blanket salt. As would be known by a skilled worker, analytical methods such as multigroup calculations or numerical methods, such as the commonly used Monte Carlo N-Particle transport code (MCNP), can be used to determine the dimensions needed to obtain a critical reactor. Alternatively, if an elongated core section 28 of given diameter and length exists for thermo-hydraulic reasons, the fuel salt composition can be chosen such that criticality will occur in the elongated core section in question. For example, if a fuel salt has a fissile concentration that achieves criticality in an elongated core section of a first diameter, lowering the fissile concentration would allow the fuel salt to achieve criticality in an elongated core section having a diameter larger than the first diameter; however, this would lead to increased neutron losses to the carrier salt, fission products, structure etc.

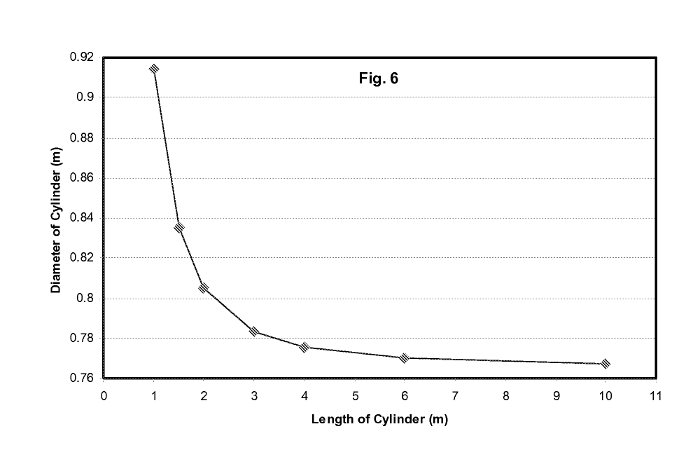

For design purposes, a very useful method exists for the calculation of reactor dimensions. This is through the use of previously calculated and well-known spherical-core molten salt reactors and by using the ratio of buckling coefficients between spherical geometry and for example, elongated cylindrical geometry (see for example, Chapter 6, Introduction to Nuclear Engineering, 2^{nd} Edition, by John R. Lamarsh, Addison-Wesley Publishing Company (1983)). For a sphere the buckling is given by Bₛₚₕₑᵣₑ=π/R where R is the radius of the sphere. For a finite cylinder it is B_{cylinder}=((2.405/R)²+(π/H)²)/^{1/2} where H is the height (length) of the cylindrical core. To a first approximation, the ratio between Bₛₚₕₑᵣₑ and B_{cylinder} gives the ratio of critical radius or diameter. The buckling coefficients used by Lamarsh are applicable to bare reactors, i.e., reactors without any neutron reflectors at their periphery; however, the embodiment of FIG. 4, has the elongated core section 28 surrounded by a blanket 30, which behaves as only a weak reflector due to the high neutron absorption property of the fertile elements present. Therefore, because of the relative weakness of the blanket in terms of reflection of neutrons, the present approximation should be quite accurate. Using this approach, by considering first a 1 m diameter critical spherical core, it is possible to calculate the dimensions of a corresponding critical cylindrical core. FIG. 6 shows a plot of the critical diameter of such a cylinder as a function of its length. As shown in the plot of FIG. 6, for example, a cylindrical core reactor of about 0.77 m in diameter and 10 m in length would be critical. However, this 10 m-long cylindrical core reactor will have a power producing volume of 4.66 m³ whereas the 1 m diameter sphere has only 0.53 m³ of power producing volume. Accordingly, a molten-salt reactor with a reactor core assembly 20 can produce substantially more power than its spherical reactor core counterpart.

The embodiment of FIG. 4, with its physical layout of the fuel salt conduit 22 and of the vessel wall 31 can minimize the loss of neutrons generated within the elongated core section 28. For the elongated nuclear core section 28, entry and exit of the fuel salt can be at either end of elongated core section. Due to the low ratio of surface area of the cylinder ends compared to the cylinder sidewall, this geometry can save on neutron losses. To help further minimize neutron loss it is possible to constrict the diameter of the elongated core section 28 at each end while it is still surrounded by the fertile material contained in the blanket 30. The constriction at the input end section is shown at reference numeral 32 while that at the output end section is shown at 34. These constrictions are formed by the girth of the of the input end section and of the output end section diminishing as the respective input end section and output end section extend away from the elongated nuclear core section. These constrictions cause the fuel salt conduit 20 to become subcritical substantially at the onset of the constrictions 32 and 34, which means a lower production rate of neutrons in the constrictions 32 and 34. Accordingly, with the blanket 30 continuing past the points of minimum constriction 36 and 38, there will be almost no neutrons lost to end leakage. That is, a significant number of neutrons exiting the elongated core section 28 through the constrictions 32 and 34 will be captured by the blanket 30 and lead to the production of fissile elements. Stated otherwise, this means that more fertile material present in the blanket region 50 can be converted into fissile material.

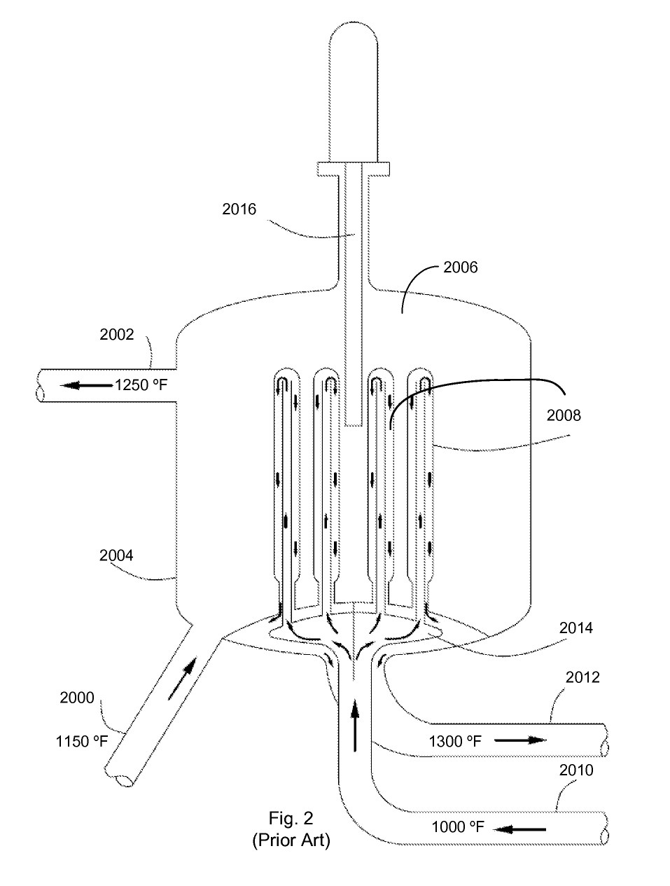

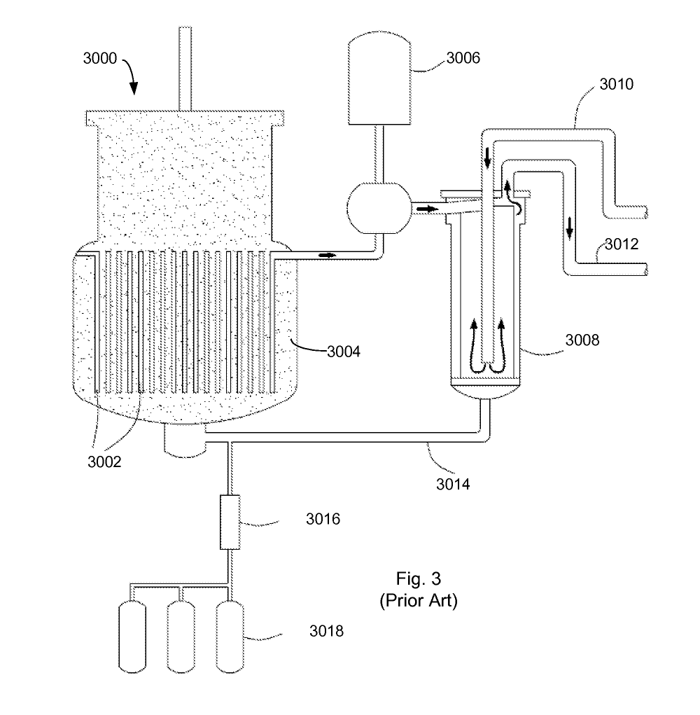

For the reactor core assembly 20 of FIG. 4, the temperature and void reactivity coefficients of both the fuel and blanket salts are negative. The fuel salt coefficients are negative mainly due to the fact that thermal expansion or voiding removes fissile material from the core. For the blanket salt, it acts as a weak reflector of neutrons back into the core. This means that the core reactivity will lower if the blanket density drops due to increasing temperature or voiding since neutron loss by leakage would then increase. Thus, the blanket will have negative temperature and void reactivity coefficients, as desired. These coefficients being negative, for both fuel and blanket salts, mean that any increase in power in the elongated reactor core 28, or loss of cooling effected by a heat exchanger system (not shown) will result in an automatic decrease in reactor power output. This feature is contrary to the prior molten salt reactors shown at FIGS. 2 and 3 The Two Fluid design of FIG. 2 was always known to have positive terms for the blanket salt, which was deemed unavoidable but manageable. The Single Fluid design of FIG. 3 was only recently shown to in fact have a slightly positive overall or global temperature coefficient.

FIG. 5 shows a cross-section of the reactor core assembly 20 of FIG. 4. Although the embodiment of FIGS. 4 and 5 has a cylindrical geometry, any other suitable elongated core geometry, such as, for example, a slab geometry, is possible. As will be described below, any suitable molten salt with various combinations of fissile and fertile isotopes can be used to power the reactor core assembly of FIGS. 4 and 5.

In the exemplary reactor core assembly 20 of FIGS. 4 and 5, there is no added graphite moderator in the elongated core section 28 and as such, this configuration can be said to have a homogeneous core. However, when the fuel salt conduit 22 is itself made of graphite or carbon composite of any suitable thickness, it will act to moderate neutrons. As for the blanket 30, it can include a fertile material such as ThF₄ mixed in with a carrier salt such as, for example, ⁷LiF or NaF. Graphite moderation can also be employed in the blanket region if desired. The vessel wall 31 can be made of Hastelloy™ N and can include a graphite liner/reflector. If the thickness of the blanket is sufficiently thick, the neutron flux at the vessel wall 31 will be low and as such, neutron-induced damage on the vessel wall will be low. It should be noted that in this exemplary reactor, the excessive use of graphite or other moderator in the blanket or vessel wall region can cause the blanket salt to have a positive temperature or void reactivity coefficient.

As will be understood by the skilled worker, the absence of graphite from the embodiment shown at FIGS. 4 and 5 can overcome any need to replace the graphite periodically because of radiation-induced damage. As will also be understood by the skilled worker, the carrier salt flowing in the fuel salt conduit 22, for example 2Li⁷F—BeF₂, can provide a significant amount of neutron moderation, thus the neutron energy spectrum can be varied greatly by the choice of carrier salt and fissile concentration. Such carrier salts include, for example, NaF—ZrF₄, NaF—BeF₂, NaF—LiF—BeF₂.

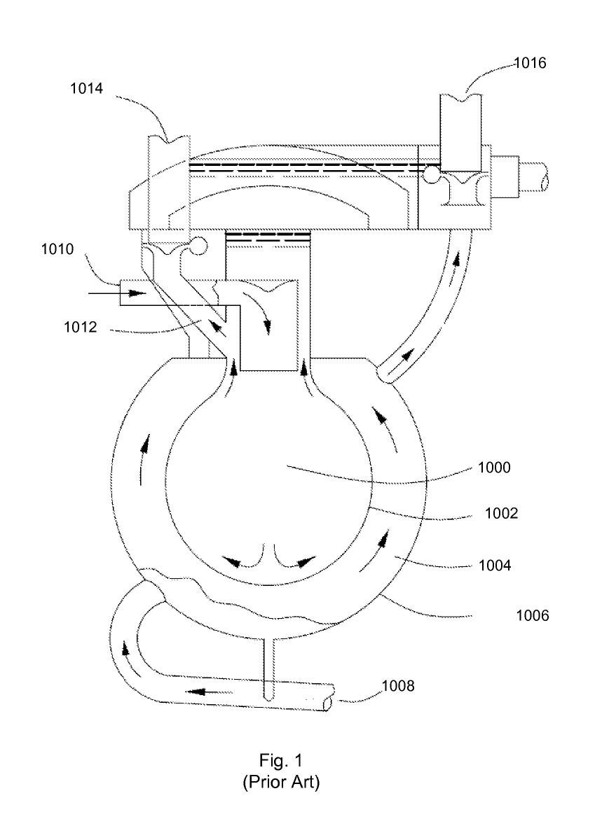

A core arrangement using a Hastelloy™ N core wall but in spherical geometry was the first proposed molten salt breeder reactor from ORNL (FIG. 1) and data from this early period, particularly from the report ORNL-2751, can be used for approximate calculation purposes. Using that data as a guide, the needed fissile concentration to break even (breeding ratio of 1.0) with a fairly slow fuel salt processing time of 6 months to a year can be estimated. Fuel salt processing relates to the removal of fission products using for example, vacuum distillation. If the core wall is a Hastelloy™ N wall of about 4 mm thickness, a long cylindrical core of about 70 cm diameter and containing 0.6% ²³³UF₄ fissile fuel in 2Li⁷F—BeF₂ (67% Li, 33% BeF2) would be critical and suffice to attain a breeding ratio of 1.0. If the wall of the fuel salt conduit 22 has a low neutron cross section such as provided by graphite or other carbon based material, then a fissile concentration of about 0.16% ²³³UF₄ would require a long cylindrical core diameter of about 94 cm to be critical and would still yield a breeding ratio of 1.0 with perhaps a somewhat faster reprocessing rate for the fissile fuel salt.

The case with 0.16% ²³³UF₄ in an elongated cylindrical geometry such as shown at FIGS. 4 and 5 for a core diameter of approximately 94 cm (77% of the spherical case, which is approximately 1.22 meter) is as follows. Assuming a modest flow rate of 3 m/sec through the core, an inlet temperature of 565° C., an outlet of 705° C. and taking into account the density and specific heat of the above-stated salt mixtures gives a thermal production rate of 1367 MW (thermal). Using the conversion efficiency of 44% of a steam cycle gives 601 MW (electrical) while a Brayton closed gas cycle should be somewhat higher. A power density in the core of 400 kw/L would mean a core length of 4.9 meters while a more modest power density of 250 kw/L would mean a 7.9 m core. As will be understood by the skilled worker, a higher fissile concentration would require a smaller diameter of the elongated core section 28 and result in less power per core, assuming other parameters are kept similar.

The vessel wall 31 shown at FIGS. 4 and 5 can serve to contain the fertile molten salt and act as a thermal barrier between the blanket 50 and the exterior of the reactor. The vessel wall 31 can also function to reflect or absorb any neutrons making it through the blanket 30. The vessel wall 31 can be made of any suitable material such as, for example, corrosion resistant alloys (e.g., Hastelloy™ N), stainless steel. Graphite can also be part of the vessel wall 51 to act as a neutron reflector. Beyond the constrictions 32 and 34, the vessel wall 31 can be joined to the fuel salt conduit 22 in any suitable manner. Any suitable entry and exit points to allow for the fertile salt to flow through the blanket 30 can be used.

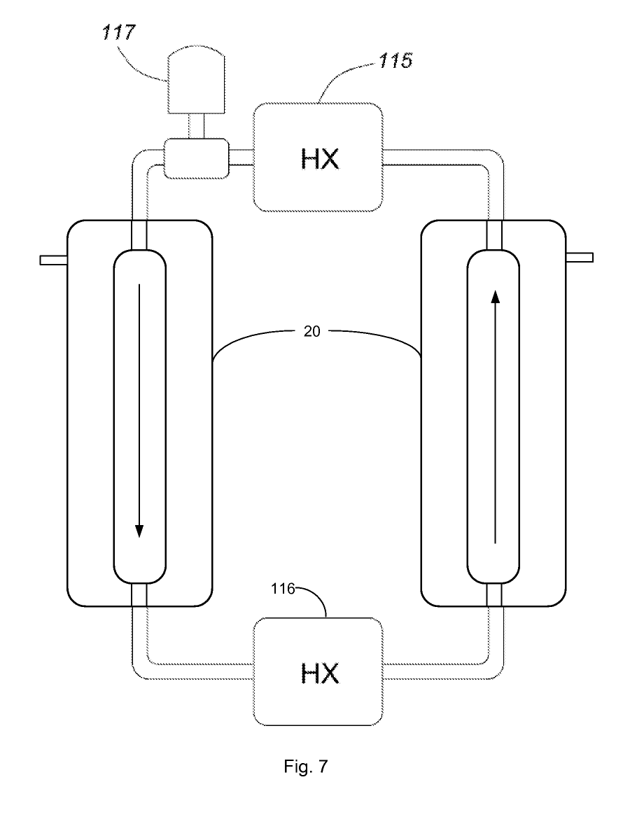

The present invention also provides for tandem operation of two reactor core assemblies as shown at FIG. 7, which illustrates a closed circuit of two reactor core assemblies 20, each connected to a respective heat exchanger (115, 116); a fuel pump 117 is also shown. The configuration shown at FIG. 7 provides for a relatively large amount of fissile fuel present in the reactor core assemblies with respect to the total amount of fissile fuel present in the core assemblies, the heat exchangers and the piping connecting the core assemblies to the heat exchangers. As will be understood by the skilled worker, this lowers the amount of fuel salt outside the core which diminishes the loss of delayed neutrons and decreases the amount of fissile material required per reactor core assembly 20.

Numerous other configurations than that shown at FIGS. 4 and 5 are possible. For example, in another embodiment, there can be a taper in the elongated core section 28, the taper being such that the elongated core section 28 increases in diameter in the direction of flow of the molten salt in the fuel salt conduit 22, i.e., in the direction going from the input end section 24 to the output end section 26. That is, the diameter of the core is narrower at the entry end and wider near the exit of the elongated reactor core section 28. The reason for this is that the carrier salt will be increasing in temperature as it propagates through the core and thus, will decrease in density. By having the taper along the length, the reactivity or the neutron multiplication factor can be kept more uniform along the length.

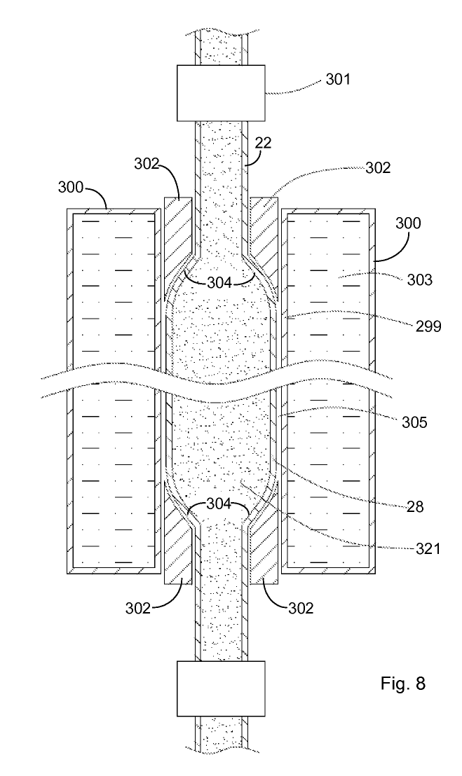

Another exemplary embodiment of the molten salt nuclear core assembly of the present invention is shown is shown at FIG. 8 where a calandria configuration is depicted. The elongated core section 28, which contains a fuel salt 321, is shown surrounded by a shell blanket 300 containing blanket salt 303 and having a wall 299. The calandria configuration allows for any suitable reflector material 302 (e.g., graphite or steel) to be disposed adjacent constrictions 304. The calandria configuration also allows for differential expansion between the fuel salt conduit 22 and the shell blanket 300, which in turn simplifies the replacement of the fuel salt conduit 22. The differential expansion in question is possible because of a gap 305, which can include an insulating material. Expansion bellows 301 can be used to connect the fuel salt conduit 22 to piping beyond the nuclear core region and to accommodate linear expansion of the fuel salt conduit 22 due to, for example, temperature or radiation induced swelling.

In another embodiment of the invention, the barrier between the core and blanket made from a neutron moderator material of appreciable thickness. In the case of the fuel salt conduit 22 of FIGS. 4 and 5, the elongated core section 28 would be made of such a moderator material. For example, a thick walled graphite tube would form the elongated core section 28; however, more complex arrangements such as canned beryllium oxide or even insulated heavy water could be envisioned. For a graphite tube, a thickness of 10 to 20 cm should be possible before gamma and neutron heating would require additional cooling such as provided by salt channels in the moderator material. The advantage of such design is that the barrier would now act as a neutron reflector and significantly increase the thermalization of neutrons, which leads to either smaller core diameter or lower fissile concentration.

Further, moderator materials of any suitable geometry can be included in the elongated core section 28 and can be made of any suitable material such as, for example, graphite. The molten salt mixture in question flows into the elongated core section 28 at one the input end section 24 and exits though the output end section before propagating towards a heat exchanger system. The elongated core section 28 can be oriented in any suitable way including, for example, a vertical orientation or a horizontal orientation. The elongated core section 28 can have any suitable diameter as long as it allows nuclear reactions occurring therein to be self-sustaining, i.e., as long as it allows criticality to be reached. The diameter of the elongated core section 28 is thus related to the particular molten salt mixture that flows therethrough.

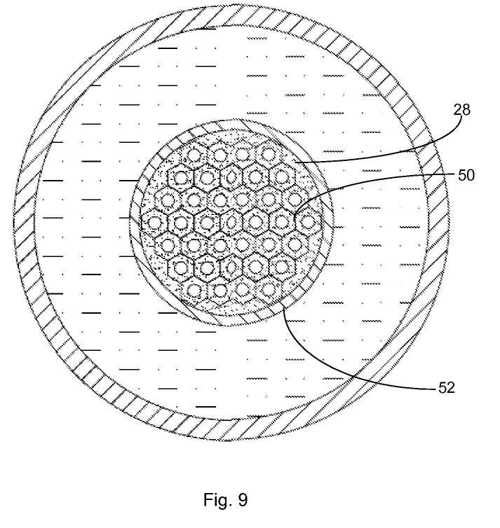

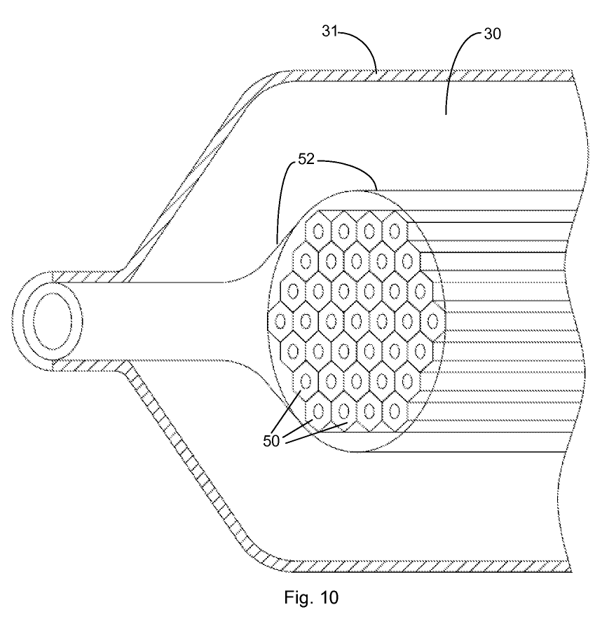

Another exemplary embodiment of a reactor core assembly of the present invention is depicted as a cross-section at FIGS. 9 and 10 where a moderator material in the form of stacked hexagonal graphite tubes 50 is shown. The fuel salt flows through these tubes 50. A barrier 52, which is part of the fuel salt conduit 22, is between the elongated core section 28 and the blanket 50 can be used. The barrier 52 can extend beyond the graphite tubes 50 and be constricted to subcritical geometry as shown at FIG. 10. A fuel salt in this embodiment can be 2Li⁷F—BeF₂ with 0.3%²³³UF₄ (molar percentage). A core region of 80% graphite and 20% fuel salt would have an approximate critical diameter of about 1 meter. As will be understood by the skilled worker, a higher fissile concentration would give a smaller critical diameter and a lower fissile concentration a larger one. Further, although FIGS. 9 and 10 show the graphite tubes 50 as having hexagonal cross-sections, any suitable material having any suitable cross-section can be used.

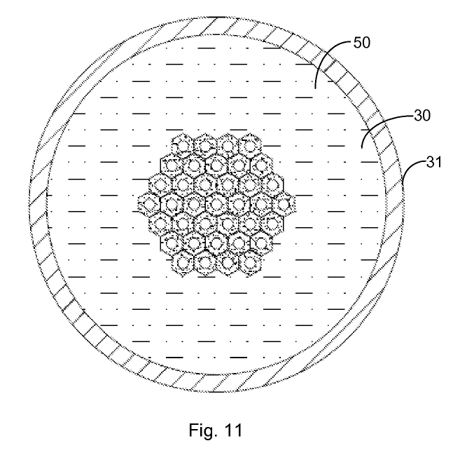

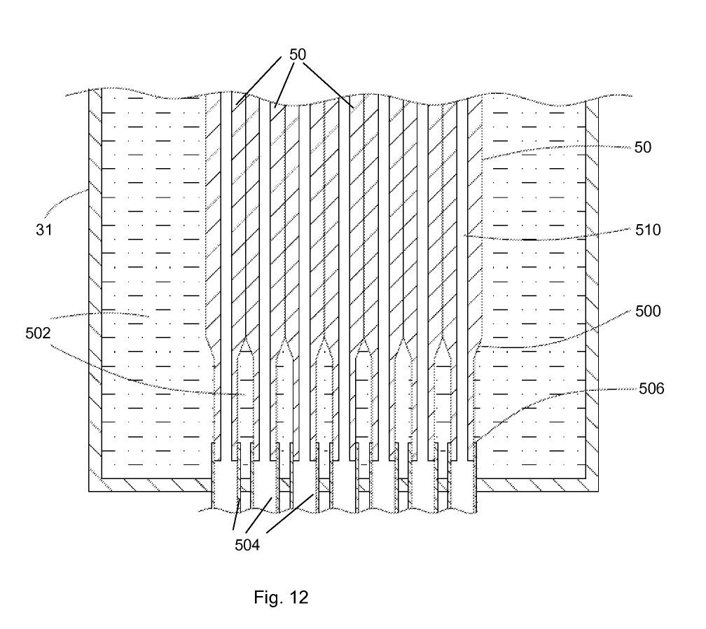

FIGS. 11 and 12 show stacked hexagonal graphite tubes 50 are in direct contact with the blanker salt instead of being separated therefrom by a barrier. FIG. 12 shows an embodiment of the invention where each individual tube 50 has an end 500 tapered, which allows for blanket salt 502 to flow between the tubes near where the tubes 50 are connected to, for example, to Hastelloy™ N piping 504 by brazing 506. The tubes 50 have a central fuel channel 510. The flow of blanket salt between the tubes causes increased neutron absorption, which in turns leads to sub-criticality in that part of the tubes to limit neutron leakage at the ends. In the core region itself however, the individual tubes 50 are close packed such that blanket salt is excluded in between tubes 50. The result is that any expansion or contraction of the graphite tubes 50 will not adversely affect reactivity, as was the case with some prior art Two-Fluid MSNR such as in FIG. 2.

Based on the exemplary values above, basic thermodynamic quantities can be estimated by using input values typically used at ORNL. For a 1 meter diameter elongated reactor core assuming a flow rate of 4.5 m/sec through the graphite channels, an inlet temperature of 565° C., an outlet of 705° C. and taking into account the density and specific heat of the above-stated 2Li⁷F—BeF₂ salt mixtures gives a thermal production rate of 464 MW (thermal). Using the conversion efficiency of 44% of a Rankin steam cycle gives 204 MW (electrical) while a Brayton gas cycle would be somewhat higher. An average power density in the core of 80 kw/L (400 kw/L in the salt) would mean a core length of 7.4 meters. At this power density it is estimated that graphite swelling may lead to the need for graphite replacement every 2 to 4 years. In order for such a reactor to merely have a break even breeding ratio of 1.0, the processing time to remove rare earth fission is expected to be on the order of 6 months to a year. One such nuclear core of this size can be used for a modest size power plant; however several such nuclear cores could be combined to form a larger power plant. In one embodiment, all the nuclear cores can feed the same steam or closed gas turbine. Having multiple nuclear cores can have many advantages, including continued plant operation if one core is shut down for maintenance or graphite replacement.

If the fissile concentration of 0.3%²³³UF₄ is lowered and power density kept the same, there will be higher neutron fluence, shorter graphite lifetime and faster reprocessing needed for fission products to break even. However, at the same time, this would result in a larger diameter core and thus more power per unit length, which would in turn lower the specific inventory. It appears likely that a level of 0.1% ²³³UF₄ can still break even with a modestly fast reprocessing time for fission products. At this concentration, with a total fuel salt volume of 15 cubic meters (for 1000 MW(e)), attainable in the exemplary examples above, the specific inventory would be less than 200 kg (compared to 1500 kg for a Single Fluid molten salt breeder reactor, 3000 to 5000 kg for typical light water reactor (LWR), and 10 to 20 tonnes for a liquid metal cooled fast breeder). As will be understood by the skilled worker, increasing the fissile concentration would have opposite results.

The separation of the elongated core section 28 from the blanket 30 is effected by the fuel salt conduit 22, which can be made of any suitable material and also operate as a neutron moderator. The blanket 30 can include, for example, any suitable fertile isotopes, carrier salt and moderator materials such as, for example, graphite. For example, the fertile isotope can be ThF₄ in a Li⁷F carrier salt. This particular mixture has a 565° C. melting point for 29% ThF₄-71% Li⁷F concentrations. As a variant, the blanket 30 can include heavy water containing a slurry of thorium compounds or thorium metal within removable, zircalloy clad rods. In operation, the blanket 30 can also contain small amounts of fissile isotopes produced through conversion of fertile material and small amounts of fission products. The blanket 30 can have any suitable geometry and can be of any suitable thickness.

In another embodiment (not shown), the blanket 30 can be solid in nature, i.e. be in the form of a liner. An example of such a blanket 30 include thorium metal, thorium carbide (ThC), thorium fluoride, thorium dioxide and/or any other suitable thorium compound embedded in a graphite matrix that acts as a liner blanket with the usual function of converting neutron leakage into fissile production. In the case where the blanket 30 is solid, it can be periodically removed and processed to transfer produced fissile elements from the blanket 30 to the elongated core section 28. Alternatively the produced fissile elements, for example ²³³U, can be allowed to remain in the blanket 30 and potentially fission at a later time, while still performing the necessary blanket function of limiting neutron leakage. A solid blanket arrangement can be made with cooling channels defined within the blanket 30 and can use the fuel salt to cool the solid blanket. In a properly designed solid blanket, fission gasses such as Xenon, which have very high neutron cross-sections and are therefore undesirable, are able to leak out of the matrix and into the core salt. In general a solid blanket would lead to an increase in neutron losses to fission products and protactinium, as they will reside in highest concentration where neutron flux is the highest in the blanket 30, i.e. near the interface of core and blanket. In designs with significant fertile elements in the core salt, the overall fraction of neutrons that would make it to this outer layer would be a small fraction, for example under 5%. This embodiment allows the major neutron economy benefits of a two-zone core and blanket arrangement without a barrier, which is a very significant advance.

Operationally, a solid blanket 30 embedded with fertile elements may need to be periodically replaced due to neutron damage, as would any graphite liner/reflector. However, a large, lower power density core could allow many years, perhaps even the entire plant lifetime before replacement. Another change in operation would be the need to process small amounts of decay heat from this liner if the core salt is drained to storage tanks. There will be a small percentage of power produced in the liner, likely under 5% (possibly under 2%) which would lead to the same relative proportion of decay heat. However, the liner does not need to be thick and since it is in contact with the vessel wall 31, decay heat can be dealt with by heat transfer through the graphite and then to the vessel wall 31. From there, the heat can transfer to the surrounding containment atmosphere or a cooling mechanism can be added to the vessel wall. This need to conduct heat to the outer vessel wall to removed decay heat is much smaller, but similar in nature, to most high temperature, graphite fuel matrix, gas-cooled reactors as is known to those experienced in the art. As will be understood by the skilled worker, the proposed solid fertile blanket can be used not only with a reactor having an elongated core section, but with any suitable reactor core geometries.

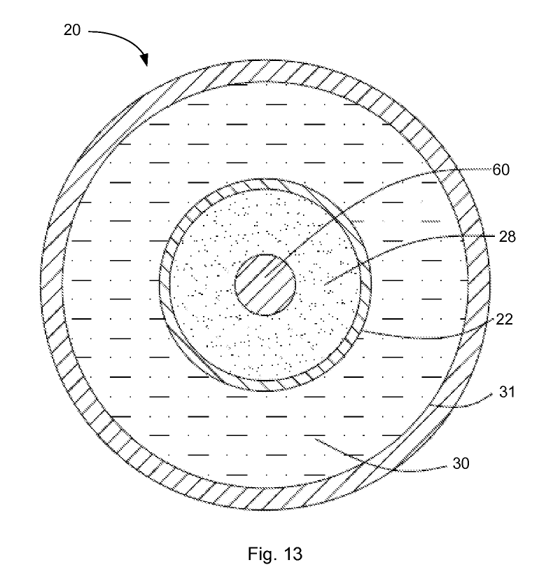

Another embodiment of the present invention is shown at FIG. 13 were a moderator material 60 is placed at the centre of the elongated core section 28 or at any other suitable location within the elongated core section 28. In this case the central moderator helps thermalize the neutron spectrum to increase reactivity in the core. This configuration can also lead to what is known in the art as hybrid neutron energy spectrum. The spectrum near the boundary of the moderator will be well thermalized, while further away in the core the spectrum will be harder. This in a sense gives advantages of both spectrums with the main benefit being a much longer effective prompt neutron lifetime. As is known in the art, if 5% of fissions come from thermal energy neutrons, then the longer prompt lifetime of these neutrons will control the reactor unless criticality is exceeded by more than 5%. Having the added moderator in the central position as opposed to the barrier means that the neutron fluence, and thus neutron damage, will be minimized at the barrier. As well, for a central moderator, swelling or even cracking does not lead to significant problems and, if necessary, it is easier to replace.

In another exemplary embodiment of the invention, graphite balls can be added in the core region to act as a neutron moderator. A random or ordered bed of graphite balls instead of graphite tubes can be advantageous in that the radiation induced swelling is much more easily handled and the graphite balls themselves can be cycled out of the core for inspection and periodic replacement. A random pebble bed has been projected to have a salt volume of 37% and a graphite volume of 63%. Other shapes or multiple sizes of balls are also possible and can be used adjust the salt volume percentage.

Operation of the above-described nuclear reactor core assembly embodiments with denatured fissile materials such as, for example, denatured uranium is expected to be more practical than in prior art molten salt reactors. The above-noted nuclear reactor core assemblies can begin operation on denatured uranium and perhaps thorium in the core fuel salt and thorium plus natural or depleted uranium in the blanket fertile salt. The amount of ²³⁸U in the fertile salt of the blanket is monitored through known means and kept at such a level that as ²³³U is produced in the blanket to be periodically transferred to the fuel salt conduit 22 and the elongated core section 28, it remains in a denatured state (i.e., <12% ²³³U). Thus, as ²³³U is fluorinated out of the blanket salt, it is replaced by an appropriate amount of ²³⁸U and thorium. Very small amounts of plutonium will be produced in the blanket salt and may need to be processed out and added to the fuel salt but only on a very long time scale. In the fuel salt, it may be necessary to add extra ²³⁸U if its consumption outpaces that of ²³³U in the core or to add thorium to the fuel salt if the reverse is true. Processing for fission products in the fuel salt may most likely require that plutonium and other transuranics elements be separately removed and returned to the fuel salt. This added complication can be true of any molten salt reactor wishing to employ denatured, self sustaining operation without sending excessive amounts of transuranic elements to a waste stream. Removal of transuranics is known and can be effected through the liquid bismuth extraction technique as well as an alternate form of the fluoride volatility process.

Denatured operation without graphite moderation in the elongated core section 28 is feasible but requires the reactor to run with a higher specific inventory and significantly harder spectrum, mainly to overcome ²³⁸U resonant absorptions. This operation on denatured uranium is superior over prior art Single Fluid reactors in terms of protactinium and neutron leakage losses, and also in terms of the practical limit of denatured uranium concentration in the fuel salt, which is much higher in the above-described Two Fluid reactor than in prior art Single Fluid molten salt reactors. This is due to the fact that the combined concentration of thorium plus uranium in a characteristic LiF—BeF2, e.g., 67% LiF-33% BeF2, carrier salt is typically around 14% molar before the melting point raises too high for ease of use with Hastelloy™ N with an attractive inlet to outlet temperature difference. In prior art Single Fluid reactors, the 14% in question is shared by both thorium and uranium whereas in the Two Fluid reactor of the present invention, and in other prior art Two-Fluid reactors, it can relate entirely to denatured UF₄, i.e., the fuel salt can be made to contain no thorium As will be understood by the skilled worker, having all uranium remain in a denatured state decreases risks of nuclear proliferation

The molten salt nuclear reactor of the present invention can operate on transuranic (TRU) waste from such sources as Light Water Reactor (LWR). At present, there are several thousand tonnes of such waste worldwide that represents a very serious disposal issue due to long term radiotoxicity as well as a proliferation risk. The presently disclosed embodiment of the invention has again the same basic core and surrounding blanket arrangement as shown at FIG. 4. However, in this case, the core salt contains TRUs (e.g., PuF₃, AmF₃, NpF₄,) and ThF₄ in the blanket. While having adequate reactivity at startup is not an issue as LWR transuranic wastes have a relatively high fissile to fertile ratio, as TRUs are fissioned and/or transmuted to higher isotopes and more TRUs are added, this ratio drops. Without further intervention, this means that the reactor can lose the ability to remain critical because of the limited solubility of tri-fluoride TRUs. In the present embodiment however, the majority of neutrons leaking from the core region into the blanket 30 will have been producing ²³³U, which can be transferred to the core salt to augment the fissile concentration. Adding UF₄ does not affect the solubility of the tri-fluoride TRUs and thus the added fissile content may keep the core critical even with such carrier salts as NaF—ZrF₄. Thus, long-term operation sees the continued addition and destruction of TRUs while reactivity is kept adequate by blanket-produced ²³³U. The period between fission product processing can also be lengthened due to the superior neutron economy afforded by the conversion of leakage neutrons to ²³³U.

Another major advantage of burning TRUs in the molten salt nuclear reactor of the present invention is that at some point in time the addition of TRUs can be stopped and the reactor can continue to operate to fission off the remaining TRUs. This should be possible by a gradual switch over to the pure Th—²³³U cycle. In order to maintain a similar fissile to fertile ratio within the core, thorium will likely now need to be added to the core. If break-even operation proves difficult, it is possible to transfer all actinides (e.g., UF₄, NpF₄, PuF₃, AmF₃ etc.) to a neutronically superior carrier salt such as 2LiF—BeF₂ to then complete the destruction of the TRUs. Alternatively, if needed, small amounts of ²³³U can be stockpiled during the years of operation as a TRU burner to be added to the fuel salt to compensate for the cessation of TRU additions. As any TRU burning plant will already have extra security requirements due to the proliferation risks of arriving TRUs, the use of ²³³U in this manner is not expected to cause additional security risks.

The molten salt nuclear reactor of the present invention can start up a Th—²³³U cycle on transuranic wastes. In this case, operation is similar to that described above in relation to burning TRUs. The TRUs are the initial fuel within the elongated core section 28 and thorium is producing ²³³U in the surrounding blanket. The elongated core section 28 can contain neutron moderators (e.g., graphite moderator) or simply the TRUs in a carrier salt. As the ²³³U inventory builds up from the blanket 30, additions of TRUs can be cut back and eventually halted, ideally with the remaining TRUs eventually consumed in the core region. Alternatively, if complete TRU destruction is not an overriding priority, a much simpler startup procedure could be to forego with any fission product processing in the core salt as TRUs burn and more are added. Before fission product poisoning, or before the drop in fissile/fertile ratio overrides criticality, it may be possible to stockpile enough ²³³U from the blanket to restart as a pure Th—²³³U cycle with fresh carrier salt. The TRUs remaining in the core salt are still a disposal problem but at least, in this process, the net amount of existing TRUs has dropped. As a pure Th—²³³U cycle may require as little as 200 kg/GW(e) of ²³³U, operation of the reactor on TRUs for perhaps as little as a year or less could be enough to create the needed amount of ²³³U.

As is known, even if supplies of ²³³U for startup are available, the shipment of such to a plant poses a proliferation risk. To mitigate such risks, the molten salt nuclear reactor of the present invention can startup the Th—²³³U cycle using low enriched uranium (LEU). Starting a reactor on LEU with less than 20% ²³⁵U is beneficial as such LEU is widely available and shipments are already commonplace. Starting any type of Molten Salt Nuclear Reactor on LEU leading to a pure Th—²³³U cycle, to the inventor's knowledge, has never been suggested before.

The molten salt nuclear reactor of the present invention can facilitate the startup of the Th—²³³U cycle on LEU without the need to process the fuel salt beyond chemistry control during operation on LEU. The operational method for performing this is to start the reactor with LEU in the fuel salt and as usual, thorium in the blanket salt. As ²³³U is produced in the blanket, instead of being transferred to the elongated core section 28, it is safely stored on site, or, alternatively, can remain in the blanket 30 if the blanket salt is of sufficient volume. In order to maintain criticality in the elongated core section 28, LEU is periodically added to fuel salt. Since the maximum concentration of uranium in most carrier salts is quite high, continued additions and increasing LEU content in the elongated core section 28 is possible and criticality can be maintained for several years, even if not processed to remove fission products. While the elongated core section will fission approximately 800 kg/GW(e) per year, mainly from ²³⁵U fissions, a fraction of excess neutron production will be going towards ²³³U production in the blanket. For example, if the average number of neutrons per absorption leading to fission is about 1.8 in ²³⁵U, this means that about 0.8 neutrons per fission can be shared between fertile elements in the core, parasitic losses and thorium absorptions in the blanket. It appears reasonable that an average of half of these or 0.4 could go to thorium absorptions. This would represent a production rate then of about 320 kg of ²³³U per year. Thus a year or less operation on LEU would be adequate to then restart the molten salt reactor of the present invention with fresh carrier salt on the Th—²³³U cycle. For variations requiring a larger ²³³U startup inventory, the period during which is added to the fuel salt can be extended for 5 or more years. At the end of this period, the uranium content of the fission product laddened fuel salt can be fluorinated out and sold for use in, for example, LWR plants. The remaining salt containing fission products and some produced transuranics can be processed to whatever degree is deemed appropriate. If TRUs are thought best to be removed, they can be fissioned off slowly in the new Th—²³³U reactor. This salt processing of the original LEU salt is one time only, and can be performed by mobile facilities that can be moved from plant to plant.

Increasing fissile content in the elongated core section 28 without requiring extreme minimums of core diameter can be accomplished by adding some fertile elements to the core (e.g., adding thorium to the fuel salt, thereby operating in a One-and-a-half-fluid configuration). To retain the salt processing benefits of a thorium free salt, any thorium present in the fuel salt can simply be allowed to enter the waste stream with the fission products. As thorium is quite inexpensive and reserves are practically inexhaustible, this concept is not contrary to sustainability. A goal of less than 10 tonnes thorium wasted to 1 tonne consumed is a practical goal. A LWR once-through system roughly wastes 200 tonnes of mined uranium per tonne fissioned giving one GW(e) year of operation. The calculation of potential annual thorium losses is as simple as dividing the thorium content of the fuel salt by the processing rate in years. This processing rate can lie in the range of 0.1 to 20 years for a break even molten salt reactor.

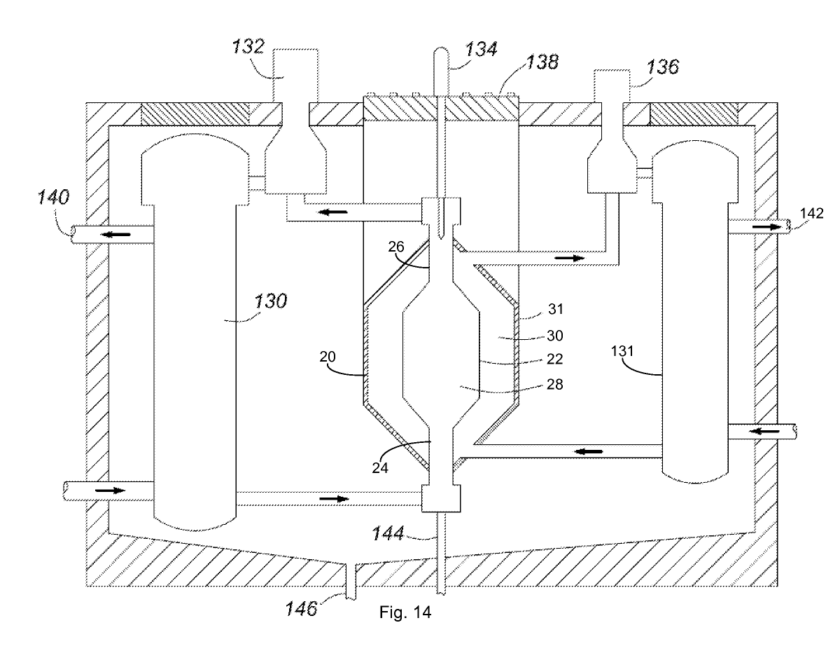

FIG. 14 shows an exemplary nuclear plant where the reactor core assembly 20 is oriented vertically and is operated in a One-and-a-half-fluid configuration. For example, 0.6% ²³³UF₄ along with 7% ThF₄ the critical diameter is expected to be just under 2 meters. A slightly elongated core of about 4 meters length and a power density of 200 kW/L gives a full 1000 MW(e) from this single core. The fuel salt conduit 22 is connected at its input end section 24 and at its output end section 26 to a first heat exchanger system 130. The blanket 50 is shown connected to a second heat exchanger system 141. A fuel salt pump 132, a shutdown/control rod mechanism 134, a blanket salt pump 136, a core access hatch 138, and intermediate coolant salt outlets 140 and 142 are also shown.

Operation of the molten salt nuclear reactor of the present invention with alternate carrier fuel salts and carrier blanket salts can benefit from a higher fissile content in the fuel salt and a harder neutron spectrum. The traditional ⁷LiF—BeF₂ carrier salt is seen as the best salt in terms of neutron interaction, but has several disadvantages in terms of high cost, toxicity and perhaps most importantly tritium production from both lithium and beryllium. Unfortunately, many carrier salt candidates with melting points below 600° C. contain either lithium or beryllium. Many potential alternates require a minimum of 10% molar or more of ThF₄ and/or UF₄ to give a lower melting point, which indicates that thorium or ²³⁸U in the elongated core section 28 would assist this goal. The most likely carrier salt constituents are NaF, ZrF₄, RbF or KF. Na has a reasonable neutron absorption cross section at all neutron energies, Zr is quite good for low but poor at high energies, Rb is good at low, very poor at high and K is poor at low but reasonably good at higher neutron energies. An example of a possible combination is that of a blanket salt of 32% NaF-29% RbF-39% ThF₄ (melting point 540° C.) and a fuel salt of 49.5% NaF-48% ZrF4-2.5% (Th+U)F₄ (melting point 510° C.). Another example of a fuel salt is 15-22% KF-45-55% NaF-25-30% (Th+U)F₄, which has a melting point ranging between 470 and 550° C.

Fission product removal is another area that can benefit from higher fissile and harder spectrum. Losses to fission products are relatively lower in a harder spectrum such that processing needs can be dramatically lowered. Past work on a homogenous core molten salt nuclear reactor with a partial thorium blanket have shown that a processing cycle of 20 years with a breeding ratio of 1.0 is possible. In such cases, vacuum distillation or even liquid bismuth extraction would only need to process a few liters per day, representing more of a bench top setup than an industrial process. Longer processing cycle times may make viable other processing methods, in particular what is know as salt discard or salt replacement. In this embodiment of the invention no fuel processing equipment is needed beyond fluorination systems to remove uranium. The method of operation would be the usual periodic fluorination of ²³³U from the thorium blanket salt and transfer to the core salt. For the core salt, it needs only to have the ²³³U content removed and returned to the core with fresh carrier salt, either on continuous basis or by batch processing.

Given the ability to greatly limit the fuel processing needs through higher fissile concentration and the significant in-core fissile production of a One-and-a-half-Fluid reactor design, an attractive novel processing option is possible for the presently described invention. This option is a method of operation, which would see no salt processing equipment of any kind needed on site. Beyond cost reductions, this would also increase proliferation resistance. The proposed method is to run the reactor for a set period of time without any fuel processing beyond simple chemistry. From a clean start, reactivity will first increase and then decrease as fission products build up. These changes can be handled by combination of changing the fuel salt operating temperature, adding burnable poison or by using a control rod. After such a period of operation, for example six months up to several years, the reactor can be shut down to process the salts. Processing equipment can be brought on site which, in the case of the salt replacement option, entails only fluoride volatility processing equipment to transfer all UF₄ from the old core salt to new carrier salt and for the transfer of blanket produced ²³³UF₄ to the new carrier salt. Alternatively, if power production is allowed to substantially transfer from core to blanket with time, it may even prove possible to run for an entire plant lifetime without any fission product processing and still attain a net break even breeding ratio.

The present invention provides a molten salt nuclear reactor having an elongated core section in which criticality is achieved. The power producing volume of the elongated core section is such that considerably more power can be extracted in comparison with prior art molten salt nuclear reactors. Many variations of the present molten salt nuclear reactor, both in terms of structural design and operations modes, have been described.

In the preceding description, for purposes of explanation, numerous details are set forth in order to provide a thorough understanding of the embodiments of the invention. However, it will be apparent to one skilled in the art that these specific details are not required in order to practice the invention.

The above-described embodiments of the invention are intended to be examples only. Alterations, modifications and variations can be effected to the particular embodiments by those of skill in the art without departing from the scope of the invention, which is defined solely by the claims appended hereto.

1. A molten salt nuclear reactor comprising:
a fuel salt conduit having an input end section, an output end section and an elongated nuclear core section formed between the input end section and the output end section, the fuel salt conduit to guide a molten fuel salt between the input end section and the output end section, the molten fuel salt having a pre-determined concentration of fissile material, the elongated nuclear core section having a length and a cross-section dimensioned in accordance with at least the pre-determined concentration of fissile materials to obtain criticality within the elongated core section.

2. The reactor as claimed in claim 1 further comprising a breeding section formed adjacent the fuel salt conduit, the breeding section to contain fertile nuclear elements and to receive neutrons generated in the elongated nuclear core section to produce fissile elements from the fertile nuclear elements.

3. The reactor as claimed in claim 2 wherein the breeding section reflects a portion of the neutrons received from the elongated nuclear core section back towards the elongated nuclear core section, the length and the cross-section of the elongated nuclear core section being dimensioned in further accordance with the portion of neutrons reflected.

4. The reactor as claimed in claim 2 wherein the breeding section surrounds the fuel salt conduit to maximize the probability of capture by the fertile elements of the breeding section of the neutrons generated in the elongated nuclear core section.

5. The reactor as claimed in claim 4 wherein at least one of the input end section and the output end section has a girth that diminishes as the a least one of the input end section and the output end section extends away from the elongated nuclear core section.

6. The reactor as claimed in claim 2 wherein the breeding section is a fertile salt conduit that propagates a molten breeder salt that includes the fertile nuclear elements.

7. The reactor as claimed in claim 6 wherein:
the fuel salt conduit is located inside the fertile salt conduit; and
the molten breeder salt surrounds the fertile salt conduit.

8. The reactor as claimed in claim 1 wherein the elongated core section is a cylinder.

9. The reactor as claimed in claim 1 further comprising a fuel salt heat exchanger system connected to the fuel salt conduit.

10. The reactor as claimed in claim 6 further comprising a breeder salt heat exchanger system connected to the fertile salt conduit.

11. The reactor as claimed in claim 1 further comprising a neutron moderator material formed inside the elongated nuclear core section.

12. The reactor as claimed in claim 11 wherein the neutron moderator material is graphite.

13. The reactor as claimed in claim 2 wherein the breeding section is a solid structure.

14. The reactor as claimed in claim 13 wherein the solid structure is a graphite matrix containing at least one of thorium metal, thorium carbide, thorium fluoride and thorium dioxide.

15. The reactor as claimed in claim 2 further comprising a vessel that houses the fuel salt conduit and the breeding section.

16. The reactor as claimed in claim 15 wherein the vessel is made of a corrosion resistant metal alloy.

17. The reactor as claimed in claim 1 wherein the elongated nuclear core section gradually increases in width between the input end section and the output end section.

18. The reactor as claimed in claim 1 wherein the fuel salt conduit is made of at least one of a corrosion resistant alloy, graphite, carbon composite, molybdenum and stainless steel.

19. The reactor as claimed in claim 11 wherein the neutron moderator material is in the form of at least one graphite tube through which the molten fuel salt flows.

20. The reactor as claimed in claim 11 wherein the neutron moderator material is in the form of a plurality of graphite tubes through which the molten fuel salt flows.

21. The reactor as claimed in claim 20 wherein the graphite tubes are stacked up on each other.

22. The reactor as claimed in claim 19 wherein a portion of the at least one graphite tube have an exterior hexagonal cross-section.

23. The reactor as claimed in claim 11 wherein the neutron moderator material is in the form of a plurality of graphite pebbles.

24. The reactor as claimed in claim 23 wherein a portion of the graphite pebbles are shaped as spheres.

25. The reactor as claimed in claim 1 wherein the elongated reactor core is made of graphite.

26. The reactor as claimed in claim 1 wherein the elongated core region includes a beryllium compound.

27. The reactor as claimed in claim 1 further comprising an enclosed volume of heavy water.

28. The reactor as claimed in claim 1 further comprising a neutron moderator material located substantially at the center of the elongated core.

29. A molten salt nuclear reactor comprising:
a fuel salt conduit having an input end section, an output end section and an elongated nuclear core section formed between the input end section and the output end section, the fuel salt conduit to guide a molten fuel salt between the input end section and the output end section through the nuclear core section, the molten fuel salt having a pre-determined concentration of fissile materials, the elongated nuclear core section having a length and a cross-section dimensioned in accordance with the pre-determined concentration of fissile materials to obtain criticality within the elongated core section, the fuel salt conduit containing at least one of thorium metal, thorium carbide, thorium fluoride and thorium dioxide.

30. The reactor of claim 29 wherein the fuel salt conduit includes a graphite matrix in which are contained the at least one of thorium metal, thorium carbide, thorium fluoride and thorium dioxide.

31. A method of operating a molten salt nuclear reactor (MSNR), the method comprising steps of:
producing a self-sustaining nuclear reaction by providing a first denatured uranium salt to a fuel salt conduit of the MSNR, the fuel salt conduit having an elongated core section, the first denatured uranium salt having a concentration of fissile uranium such that criticality is achieved in the elongated core section, the self-sustaining nuclear reaction producing neutrons;
producing an augmented concentration denatured uranium salt by providing a fertile salt adjacent the fuel salt conduit, the fertile salt containing a thorium salt and a second denatured uranium salt, a portion of thorium atoms of thorium compounds of the thorium salt capturing neutrons produced in the elongated core section to transmute into ²³³U atoms to produce ²³³U compounds, the ²³³U compounds increasing an initial concentration of fissile uranium in the second denatured uranium salt to produce the augmented concentration denatured uranium salt;
removing the augmented concentration denatured uranium salt from the fertile fuel salt;
replacing the augmented concentration denatured uranium salt with a replacement denatured uranium salt having a concentration of fissile uranium lower than that of the augmented concentration denatured uranium salt;
adding thorium salt to the fertile salt to replace thorium atoms that have transmutated into ²³³U; and
adding a portion of the augmented concentration denatured uranium salt to the fuel salt to maintain criticality in the elongated core section.

32. A method of operating a molten salt nuclear reactor (MSNR), the method comprising steps of:
producing a self-sustaining nuclear reaction by providing a fuel salt containing transuranic fissile elements to a fuel salt conduit of the MSNR, the fuel salt conduit having an elongated core section, the fuel salt having a concentration fissile elements such that criticality is achieved in the elongated core section, the self-sustaining nuclear reaction producing neutrons;
producing ²³³U compounds by providing a fertile salt adjacent the fuel salt conduit, the fertile salt containing a thorium salt, a portion of thorium atoms of thorium compounds of the thorium salt capturing neutrons produced in the elongated core section to transmute into ²³³U atoms to produce the ²³³U compounds;
extracting the ²³³U compounds from the fertile fuel salt; and
adding a portion of the extracted ²³³U compounds to the fuel salt to maintain criticality in the elongated core section.

33. A method of producing ²³³U in a molten salt nuclear reactor, the method comprising steps of:
producing a self-sustaining nuclear reaction by providing a fuel salt containing transuranic fissile elements to a fuel salt conduit of the MSNR, the fuel salt conduit having an elongated core section, the fuel salt having a concentration of transuranic fissile elements such that criticality is achieved in the elongated core section, the self-sustaining nuclear reaction producing neutrons;
producing ²³³U compounds by providing a fertile salt adjacent the fuel salt conduit, the fertile salt containing a thorium salt, a portion of thorium atoms of thorium compounds of the thorium salt capturing neutrons produced in the elongated core section to transmute into ²³³U atoms to produce the ²³³U compounds; and
extracting the ²³³U compounds from the fertile fuel salt to obtain extracted ²³³U compounds.

34. The method of claim 33 further comprising a step of replacing the fuel salt containing the transuranic fissile elements with a fuel salt containing the extracted ²³³U compounds.

35. A method of running a molten salt nuclear reactor on a Th—²³³U cycle, the method comprising steps of:
producing a self-sustaining nuclear reaction by providing a low enriched uranium (LEU) fuel salt to a fuel salt conduit of the MSNR, the fuel salt conduit having an elongated core section, the LEU fuel salt having a concentration of fissile uranium such that criticality is achieved in the elongated core section, the self-sustaining nuclear reaction producing neutrons;
producing ²³³U compounds by providing a fertile salt adjacent the fuel salt conduit, the fertile salt containing a thorium salt, a portion of thorium atoms of thorium compounds of the thorium salt capturing neutrons produced in the elongated core section to transmute into ²³³U atoms to produce the ²³³U compounds until a pre-determined start-up quantity of ²³³U compounds is reached; and
replacing the LEU fuel salt with a fuel salt comprising the pre-determined start-up quantity of ²³³U compounds.
